(19) United States
(12) Patent Application Publication
(10) Pub. No.: US 2020/0411221 A1
(43) Pub. Date: Dec. 31, 2020

(54) MAGNETIC PLATFORM AND FIXING SYSTEM UTILIZING SAME

(71) Applicant: TRIPLE WIN TECHNOLOGY(SHENZHEN) CO.LTD., Shenzhen (CN)

(72) Inventor: Chun-Guang Yan, Shenzhen (CN)

(21) Appl. No.: 16/562,941

(22) Filed: Sep. 6, 2019

(30) Foreign Application Priority Data
Jun. 28, 2019 (CN) 201910579250.8

(51) Int. Cl. H01F 7/20

(52) U.S. Cl. CPC H01F 7/206

(57) ABSTRACT

A magnetic platform which is adaptable for receiving trays of different sizes and types includes a base and a plurality of first magnets. The first magnets are fixed and held to the base by magnetic attraction. The positions of the first magnets on the base can be changed to accommodate different trays.

### FIELD

The subject matter herein generally relates to materials handling.

### BACKGROUND

A tray can be fixed on a magnetic platform by magnetism. The magnetic platform is typically an integral design that includes protruding magnets. The positions of the magnets need to correspond to the position of holes at the bottom of the tray. Thus, a magnetic platform can fix only one corresponding tray. When the type or size of tray changes, the magnetic platform has to be replaced.

Therefore, there is room for improvement within the art.

### BRIEF DESCRIPTION OF THE DRAWINGS

Implementations of the present technology will now be described, by way of embodiments, with reference to the attached figures.

FIG. 1 is a perspective view illustrating a base and a first magnet of a magnetic platform in an embodiment.

FIG. 2 is a perspective view illustrating the first magnet fixed to the base in FIG. 1.

FIG. 3 is a cross-sectional view illustrating the first magnets being released from the base.

FIG. 4 is a cross-sectional view illustrating the first magnets being fixed on the base.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

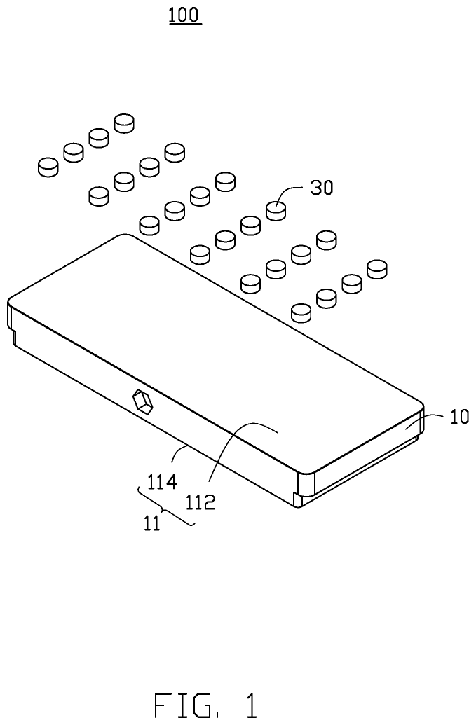

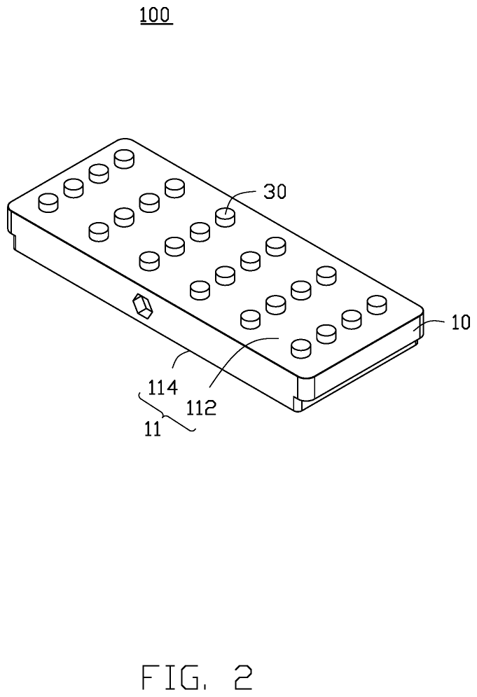

Referring to FIGS. 1 and 2, a fixing system in an embodiment includes a magnetic platform 100 and a plurality of trays (not shown in the Figs). The magnetic platform 100 is used for fixing and holding a tray.

The magnetic platform 100 includes a base 10 and a plurality of first magnets 30. The first magnets 30 are fixed to the base 10 by magnetic attraction. The positions of the first magnets 30 can be adjusted on the base 10 to accommodate different trays.

In the illustrated embodiment, the first magnets 30 are substantially cylindrical.

The base 10 is substantially rectangular.

The base 10 includes a shell 11. In the illustrated embodiment, the shell 11 is made of cast iron. In other embodiments, the shell 11 may be other materials which are magnetic in relation to the first magnets 30.

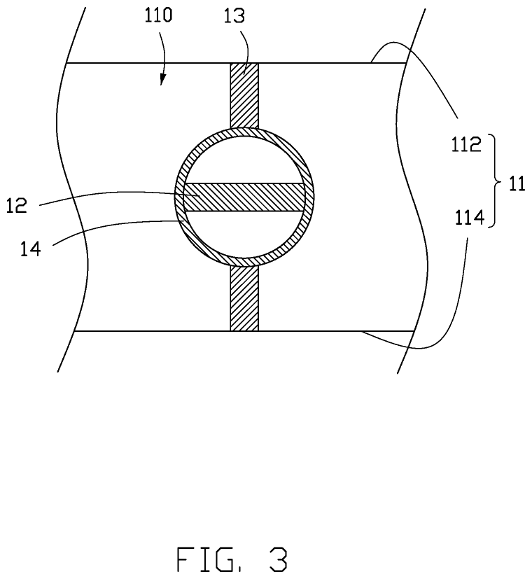

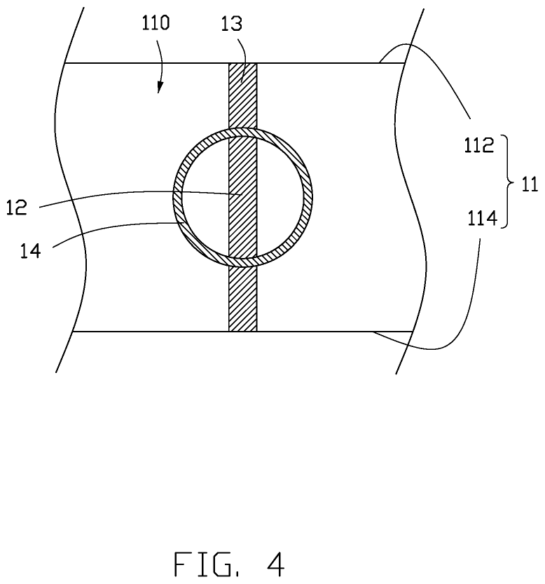

Referring to FIGS. 3 and 4, the shell 11 defines a receiving cavity 110. The shell 11 includes a first side wall 12 and a second side wall 114 opposite to each other. The first sidewall 112 and/or the second sidewall 114 can mount a plurality of first magnets 30.

In the illustrated embodiment, the base 10 further includes at least one second magnet 12. The second magnet 12 disposed in the receiving cavity 110. The second magnet 12 and the first magnets 30 attract each other to reinforce the attraction between first magnets 30 and the base 10.

In other embodiments, the second magnet 12 may be omitted, as long as the first magnets 30 can be secured to the shell 11.

In the illustrated embodiment, at least one second magnet 12 is rotatably disposed in the receiving cavity 110.

When rotating the second magnet 12, the attraction between the second magnet 12 and the first magnet 30 changes. When the first magnet 30 needs to be fixed, increase the attraction force between the second magnet 12 and the first magnet 30. When the first magnet 30 needs to be moved, reduce the attraction force between the second magnet 12 and the first magnet 30.

Depending on the space of the receiving cavity 110, the number of the second magnets 12 may be one or more, as long as the second magnet 12 can be rotated in the receiving cavity 110 and can attract the first magnet 30 with magnetism.

In other embodiments, the second magnet 12 can be fixed in the receiving cavity 110.

In the illustrated embodiment, the base 10 further includes at least one spacer 13. The spacer 13 is a non-magnetic material. The spacer 13 is fixed between the second magnet 12 and the first sidewall 112 and/or the second magnet 12 and the second sidewall 114. When the magnet 12 is rotated to bring the magnetic pole towards the spacer 13, the spacer 13 blocks magnetic lines to center the magnetic lines in the receiving cavity 110. Thus, the first magnets 30 may be moved or separated easily. When the magnet 12 is rotated to bring the magnetic pole parallel to the first sidewall 112 or the second sidewall 114, the spacer 13 is located substantially above the middle of the second magnet 12 and will block less the magnetic lines. Thus, the second magnet 12 and the first magnets 30 produce strong magnetic adsorption force.

In the illustrated embodiment, a plurality of spacers 13 is disposed between the first side wall 112 and the second sidewall 114 Two spacers 13 match one second magnet 12. The base 10 further includes at least one tube 14. The tube 14 is rotatably set in the shell 11. The tube 14 is parallel to the first side wall 112 and the second magnet 12 is set in the tube 14. Rotating the tube 14 drives the second magnet 12 to rotate and the magnet pole will move toward or away from the spacer 13.

In the illustrated embodiment, the spacer 13 is made of copper.

In other embodiments, the spacer 13 can be omitted.

In use, the second magnet 12 is rotated until its magnetic pole is towards the spacer 13. Then, the first magnets 30 are moved to be aimed at the holes of the tray. The second magnet 12 is rotated to make it parallel to the first side wall 112 or the second side wall 114 and the second magnet 12 magnetically adsorbs the first magnets 30. Place the tray on the base 10 and it is fixed by magnetic attraction.

The first magnets 30 are fixed to the base 10 by magnetic attraction. The positions of the first magnets 30 can be changed to accommodate different trays.

The embodiments shown and described above are only examples. Many such details are found in the relevant art. Therefore, such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A magnetic platform, comprising:
a base; and
a plurality of first magnets, fixed to the base by magnetic attraction,
wherein positions of the plurality of first magnets are changeable to accommodate different types of trays.

2. The magnetic platform of claim 1, wherein the base comprising a shell, the shell is made of magnetic material.

3. The magnetic platform of claim 2, wherein the shell defines a receiving cavity, the base further comprises at least one second magnet, the least one second magnet is disposed in the receiving cavity, the second magnet is configured for magnetic adsorbing the first magnets.

4. The magnetic platform of claim 3, wherein the at least one second magnet is rotatably disposed in the receiving cavity.

5. The magnetic platform of claim 4, wherein the base further comprised at least one spacer, the spacer is made of non-magnetic material, the spacer is disposed between the second magnet and the shell.

6. The magnetic platform of claim 5, wherein the spacer is made of copper.

7. The magnetic platform of claim 4, wherein the base further comprises at least one tube, the tube is rotatably mounted on the shell and extends into the receiving cavity, the second magnet is set in the tube.

8. The magnetic platform of claim 2, the shell comprises a first side wall and a second side wall opposite to the first side wall, the first side wall and/or the second side wall is configured for fixing the first magnets.

9. The magnetic platform of claim 1, the first magnet is a cylinder.

10. A fixing system, comprising:
a plurality of trays;
a platform, comprising:
a base; and
a plurality of first magnets, fixed to the base by magnetic attraction,
wherein the positions of first magnets can be changed to accommodate different types of trays.

11. The fixing system of claim 10, wherein the base comprising a shell, the shell is made by magnetic material.

12. The fixing system of claim 11, wherein the shell defines a receiving cavity, the base further comprises at least one second magnet, the least one second magnet is disposed in the receiving cavity, the second magnet is configured for magnetic adsorbing the first magnets.

13. The fixing system of claim 12, wherein the at least one second magnet is rotatably disposed in the receiving cavity.

14. The fixing system of claim 13, wherein the base further comprised at least one spacer, the spacer is made of non-magnetic material, the spacer is disposed between the second magnet and the shell.

15. The fixing system of claim 14, wherein the spacer is made of copper.

16. The fixing system of claim 13, wherein the base further comprises at least one tube, the tube is rotatably mounted on the shell and extends into the receiving cavity, the second magnet is set in the tube.

17. The fixing system of claim 11, the shell comprises a first side wall and a second side wall opposite to the first side wall, the first side wall and/or the second side wall is configured for fixing the first magnets.

18. The fixing system of claim 10, the first magnet is a cylinder.
